(19) United States
(12) Patent Application Publication
(10) Pub. No.: US 2015/0312972 A1
(43) Pub. Date: Oct. 29, 2015

(54) METHOD FOR SEALING OF GAPS IN A CONTACT SHOE RING AND SEALING ARRANGEMENT

(71) Applicant: OUTOTEC (FINLAND) OY, Espoo (FI)

(72) Inventors: Janne OLLILA, Espoo (FI); Tapio KERANEN, Espoo (FI)

(73) Assignee: Outotec (Finland) OY, Espoo (FI)

(21) Appl. No.: 14/651,600

(22) PCT Filed: Dec. 18, 2013
(86) PCT No.: PCT/FI2013/051175

§ 371 Date: Jun. 11, 2015

(30) Foreign Application Priority Data
Dec. 19, 2012 (FI) 20126332

(51) Int. Cl. H05B 7/12; H05B 7/105

(52) U.S. Cl. CPC H05B 7/12; H05B 7/105

(57) ABSTRACT

A method and sealing arrangement for sealing of gaps in a contact shoe ring. The sealing arrangement comprises a refractory fabric which is folded to a substantially U-form shape having a first branch portion attached with refractory glue to the first side edge of the first contact shoe element and a second branch portion attached with refractory glue to the second side edge of the second contact shoe element. At least one refractory felt strip is arranged between the first and second branch portions to fill the space therebetween. A cover strip made of refractory fabric is attached with refractory glue to the side faces of the first and second contact shoe element.

### FIELD OF THE INVENTION

The present invention relates to a method for sealing of gaps in a contact shoe ring. Further, the present invention relates to a sealing arrangement for sealing of gaps in a contact shoe ring.

### BACKGROUND OF THE INVENTION

A contact shoe ring is a part of an electrode lower column assembly of an electrode system of an electric arc furnace. The contact shoe ring is configured to be placed in contact with an electrode to conduct electric current to the electrode. The contact shoe ring comprises a plurality of contact shoe elements. The contact shoe elements are arranged in an annular form to surround the electrode. The contact shoes are pressed against the steel mantle of the electrode with the aid of a plurality of hydraulic bellows arranged in the pressure ring that surrounds the contact shoe ring. Each contact shoe element has two substantially vertical side edges. The adjacent contact shoes in the contact shoe ring are arranged with a substantially vertical gap between the abutting side edges of the adjacent contact shoe elements. The gap is needed to allow adaptation of the contact shoe ring diameter to variation in the diameter of the electrode and because of deformations caused by thermal expansion and because the diameter of the electrode may vary along its length. A refractory sealing arrangement is needed in the gap to prevent a gas leakage to and from the inner atmosphere of the electric arc furnace.

In prior art, the sealing arrangement has been implemented with a castable refractory mass. Castable re-fractory mass, such as ceramic mass, has been cast to seal the gap. The problem is that after being cured the ceramic mass is not elastic, but instead is hard and brittle. Therefore, the ceramic mass tends to decay and break under the influence of movements of the structures in relation to each other, such movements being caused by forces induced by thermal expansion. After breakage of the ceramic mass, maintenance is needed. The remains of broken mass have to be removed and the casting of the new ceramic mass has to be done.

### OBJECTIVE OF THE INVENTION

It is an objective to of the present invention to provide a sealing arrangement which overcomes the above-mentioned drawbacks.

It is an objective of the present invention to provide a sealing arrangement which has an ability to adapt itself to changes of the width of the gap without losing its sealing efficiency.

### SUMMARY OF THE INVENTION

According to a first aspect, the present invention provides a method for sealing of gaps in a contact shoe ring, said contact shoe ring being a subassembly of an electrode lower column assembly of an electrode system of an electric arc furnace, said electrode lower column assembly comprising said contact shoe ring and a pressure ring which surrounds the contact shoe ring, and said contact shoe ring comprising contact shoe elements, each having a first side edge, a second side edge which is substantially parallel with the first side edge, and a side face at the outer periphery facing the pressure ring, each of said gaps being a space between the first side edge of a first contact shoe element and the second side edge of a second contact shoe element which is adjacently neighboring to the first contact shoe element. According to the invention the method comprises the steps of
folding a refractory fabric to a substantially U-form shape to form a first branch portion and second branch portion which is parallel and at a distance corresponding to the width of the gap in relation to the first branch portion,
attaching the first branch portion with a refractory glue to the first side edge of the first contact shoe element,
attaching the second branch portion with a refractory glue to the second side edge of the second contact shoe element,
inserting at least one refractory felt strip between the first and second branch portions, to fill the space therebetween, and
attaching a cover strip made of refractory fabric with a refractory glue to the side faces of the first and second contact shoe elements.

According to a second aspect, the present invention provides a sealing arrangement for sealing of gaps in a contact shoe ring, said contact shoe ring being a subassembly of an electrode lower column assembly of an electrode system of an electric arc furnace, said electrode lower column assembly comprising said contact shoe ring and a pressure ring which surrounds the contact shoe ring, and said contact shoe ring comprising contact shoe elements, each having a first side edge, a second side edge which is substantially parallel with the first side edge, and a side face at the outer periphery facing the pressure ring, each of said gaps being a space between the first side edge of a first contact shoe element and the second side edge of a second contact shoe element which is adjacently neighboring to the first contact shoe element. According to the invention the sealing arrangement comprises
a refractory fabric which is folded to a substantially U-form shape having a first branch portion attached with refractory glue to the first side edge of the first contact shoe element and a second branch portion attached with refractory glue to the second side edge of the second contact shoe element,
at last one refractory felt strip which is arranged between the first and second branch portions, to fill the space therebetween, and
a cover strip made of refractory fabric attached with refractory glue to the side faces of the first and second contact shoe element.

The advantage of the invention is that the sealing arrangement comprising fabric and felt is inherently resilient and flexible so that it is capable of adapting itself to the movements and thermal expansion and contraction of the contact shoe elements without losing its sealing efficiency. Further, the sealing arrangement is very durable.

In an embodiment of the method, the method comprises a step of arranging a refractory bottom closure to connect the lower ends of the first and second branch portions, to form a support for the refractory felt strip.

In an embodiment of the method, before attaching the cover strip to the side faces of the first and second contact shoe elements, the method comprises steps of
folding a first edge portion from the first branch portion around a first corner which is the corner between the first side edge and the side face of the first contact shoe element and attaching the first edge portion with a refractory glue to said side face of the first contact shoe element, and
folding a second edge portion from the second branch portion around a second corner, which is the corner between the second side edge and the side face of the second contact shoe element, to an opposite direction in relation to the first edge portion and attaching the second edge portion with a refractory glue to said side face of the second contact shoe element.

In an embodiment the sealing arrangement comprises a refractory bottom closure connected at the lower ends of first and second branch portions, to form a bottom support for the refractory felt strip.

In an embodiment the refractory fabric comprises
a first edge portion folded from the first branch portion and attached with refractory glue to the side face of the first contact shoe element, and
a second edge portion folded from the second branch portion to an opposite direction in relation to the first edge portion and attached with refractory glue to the side face of the second contact shoe element.

In an embodiment the refractory fabric and/or the cover strip and/or the bottom closure is ceramic fabric or quartz fiber fabric.

In an embodiment the refractory felt strip is ceramic felt.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a schematic elevation side view of an electric arc furnace,

FIG. 2 is an axonometric view of a lower electrode column assembly,

FIG. 3 is a section III-III from FIG. 2,

FIG. 4 is an exploded axonometric view of the elements of the sealing arrangement according to an embodiment of the invention.

### DETAILED DESCRIPTION OF THE INVENTION

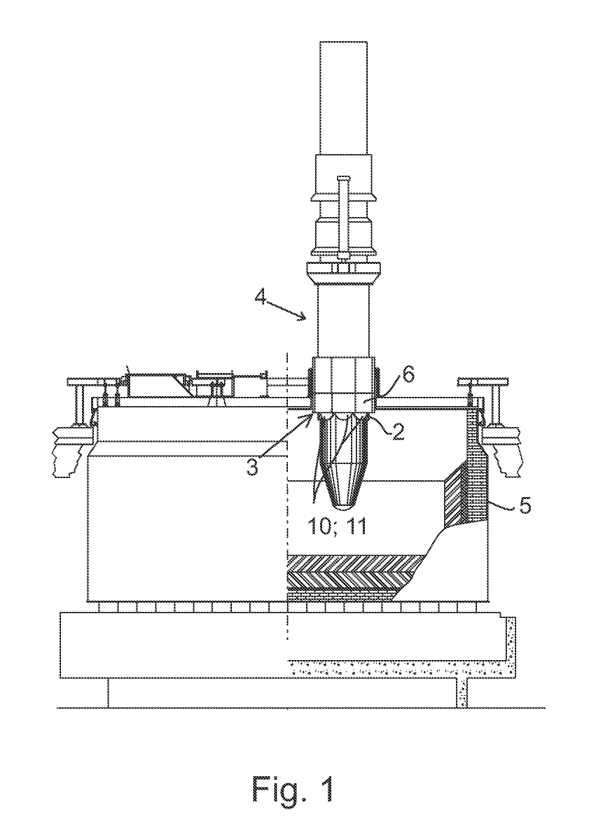

FIG. 1 shows a schematic illustration of an electric arc furnace 5. Only one of the three electrode systems 14 is shown for the sake of simplicity.

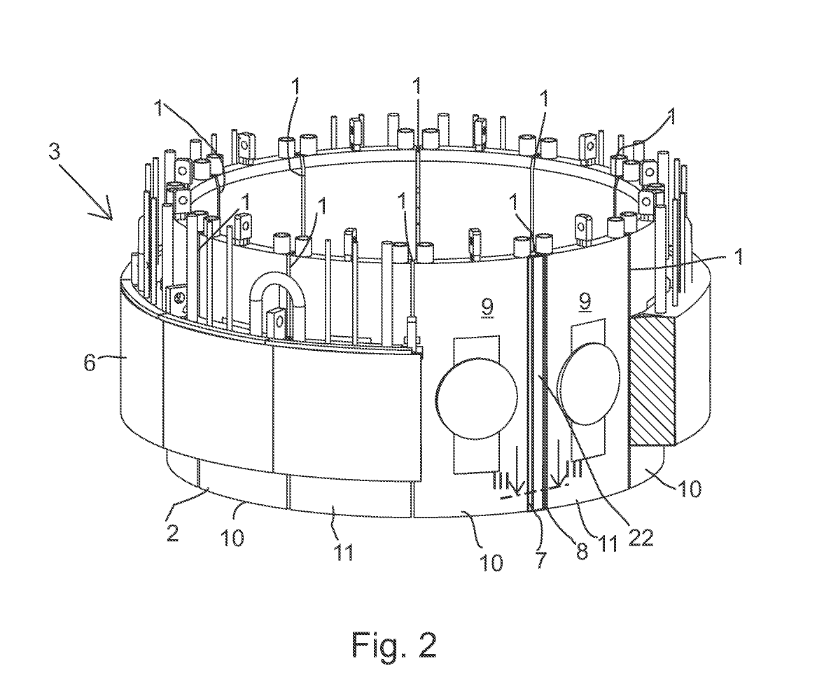

With reference to FIGS. 1 and 2 an electrode lower column assembly 3 is located in the lower part of the electrode system. The electrode lower column assembly 3 comprises a contact shoe ring 2 and a pressure ring 6. The contact shoe ring 2 is configured to be placed in contact with the electrode to conduct electric current to the electrode. The contact shoe ring 2 comprises a plurality of contact shoe elements 10, 11. The contact shoe elements are arranged in an annular form to surround the electrode. The contact shoes are pressed against the steel mantle of the electrode with the aid of a plurality of hydraulic bellows arranged in the pressure ring 6 that surrounds the contact shoe ring 2.

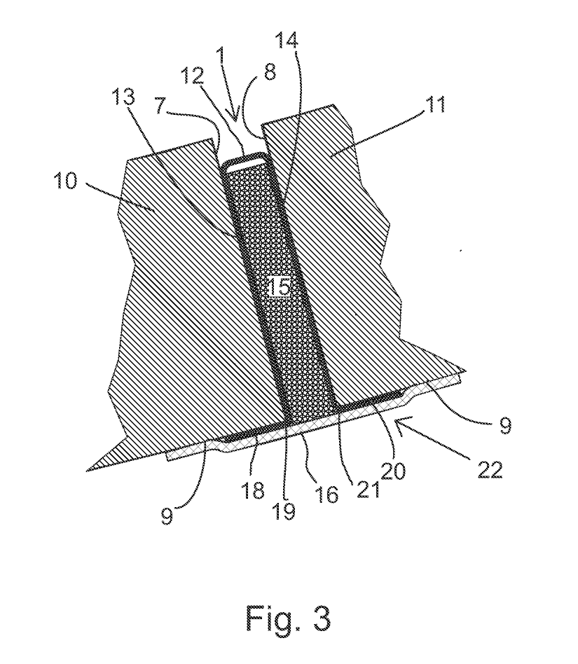

With reference to FIGS. 2 and 3, the contact shoe elements 10, 11 each have a first side edge 7, a second side edge 8 which is substantially parallel with the first side edge, and a side face 9 at the outer periphery facing the pressure ring 6. Each of the gaps 1 is a space between the first side edge 7 of a first contact shoe element 10 and the second side edge 8 of a second contact shoe element 11 which is adjacently neighboring to the first contact shoe element 10. The gaps 1 are equipped with the sealing arrangement 22, only one of which is shown in FIG. 2. The sealing arrangement 22 prevents gas leakages to and from the furnace. The inner atmosphere of the electric arc furnace includes dust and CO gas at a high temperature. Leakage of CO gas out from the furnace is a serious safety hazard and must be effectively prevented.

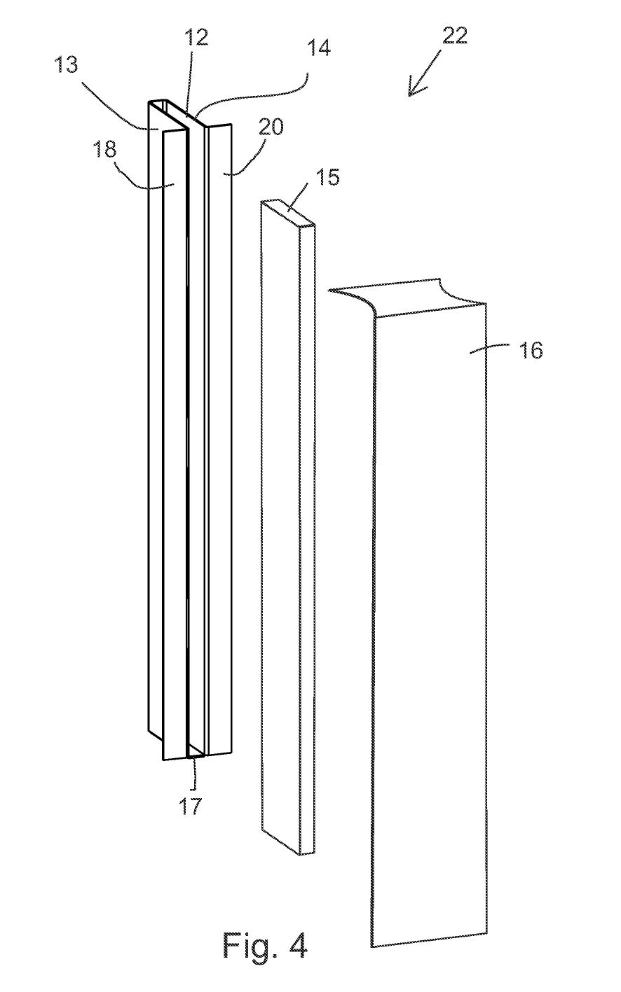

With reference to FIGS. 3 and 4, the sealing arrangement 22 comprises a refractory fabric 12 which is folded to a substantially U-form shape. In the folded shape the refractory fabric 12 has a first branch portion 13 and a second branch portion 14. The first branch portion 13 is attached with refractory glue to the first side edge 7 of the first contact shoe element 10. The second branch portion 14 is attached with refractory glue to the second side edge 8 of the second contact shoe element 11. A first edge portion 18 is folded from the first branch portion 13 and attached with refractory glue to the side face 9 of the first contact shoe element 10. A second edge portion 20 is folded from the second branch portion 14 to an opposite direction in relation to the first edge portion and attached with refractory glue to the side face 9 of the second contact shoe element 11. A refractory felt strip 15 is arranged between the first and second branch portions 13, 14 to fill the space therebetween. Finally, a cover strip 16 which is made of refractory fabric is attached with refractory glue to the side faces 9 of the first and second contact shoe element 10, 11.

As can be seen in FIG. 4, the sealing arrangement 22 comprises a refractory bottom closure 17 connected at the lower ends of first and second branch portions 13, 14 to form a bottom support for the refractory felt strip 15.

The refractory fabric 12, the cover strip 16 and the bottom closure 17 may be made of ceramic fabric or quartz fiber fabric. The refractory felt strip 15 is ceramic felt.

The sealing arrangement 22 can be installed by a method wherein a planar sheet of refractory fabric 12 is bent over, i.e. the refractory fabric 12 is folded 180 degrees, to form a substantially U-form shape so that a first branch portion 13 and second branch portion 14 are formed. A refractory bottom closure 17 is connected at the lower ends of the first and second branch portions 13, 14 to form a bottom support for a refractory felt strip 15. A first edge portion 18 is folded 90 degrees from the first branch portion 13 around a first corner 19, which is the corner between the first side edge 7 and the side face 9 of the first contact shoe element 10. Similarly, a second edge portion 20 is folded 90 degrees from the second branch portion 14 around a second corner 21, which is the corner between the second side edge 8 and the side face 9 of the second contact shoe element 11, to an opposite direction in relation to the first edge portion. The first branch portion 13 is attached with refractory glue to the first side edge 7 of the first contact shoe element 10, the second branch portion 14 is attached with a refractory glue to the second side edge 8 of the second contact shoe element 11. Further, the first edge portion 18 is attached with refractory glue to said side face 9 of the first contact shoe element 10, and the second edge portion 20 is attached with refractory glue to said side face 9 of the second contact shoe element 11. One or more refractory felt strips 15 are inserted between the first and second branch portions 13, 14 to fill the space therebetween. A cover strip 16 made of refractory fabric is attached with a refractory glue to the side faces 9 of the first and second contact shoe elements 10, 11.

While the present invention has been described in connection with an exemplary embodiment and implementations, the present invention is not so limited, but rather covers various modifications and equivalent arrangements, which fall within the purview of the following claims.

1. A method for sealing of gaps in a contact shoe ring, said contact shoe ring being a subassembly of an electrode lower column assembly of an electrode system of an electric arc furnace, said electrode lower column assembly comprising said contact shoe ring and a pressure ring which surrounds the contact shoe ring, and said contact shoe ring comprising contact shoe elements, each having a first side edge, a second side edge which is substantially parallel with the first side edge, and a side face at the outer periphery facing the pressure ring, each of said gaps being a space between the first side edge of a first contact shoe element and the second side edge of a second contact shoe element which is adjacently neighboring to the first contact shoe element, wherein the method comprises the steps of
folding a refractory fabric to a substantially U-form shape to form a first branch portion and second branch portion which is parallel and at a distance corresponding to the width of the gap in relation to the first branch portion,
attaching the first branch portion with a refractory glue to the first side edge of the first contact shoe element,
attaching the second branch portion with a refractory glue to the second side edge of the second contact shoe element,
inserting at least one refractory felt strip between the first and second branch portions to fill the space therebetween, and
attaching a cover strip made of refractory fabric with a refractory glue to the side faces of the first and second contact shoe elements.

2. The method according to claim 1, wherein the method comprises a step of arranging a refractory bottom closure to connect the lower ends of the first and second branch portions to form a support for the refractory felt strip.

3. The method according to claim 1, wherein before attaching the cover strip to the side faces of the first and second contact shoe elements, the method comprises steps of
folding a first edge portion from the first branch portion around a first corner which is the corner between the first side edge and the side face of the first contact shoe element and attaching the first edge portion with a refractory glue to said side face of the first contact shoe element, and
folding a second edge portion from the second branch portion around a second corner, which is the corner between the second side edge and the side face of the second contact shoe element, to an opposite direction in relation to the first edge portion and attaching the second edge portion with a refractory glue to said side face of the second contact shoe element.

4. A sealing arrangement for sealing of gaps in a contact shoe ring, said contact shoe ring being a subassembly of an electrode lower column assembly of an electrode system of an electric arc furnace, said electrode lower column assembly comprising said contact shoe ring and a pressure ring which surrounds the contact shoe ring, and said contact shoe ring comprising contact shoe elements, each having a first side edge, a second side edge which is substantially parallel with the first side edge, and a side face at the outer periphery facing the pressure ring, each of said gaps being a space between the first side edge of a first contact shoe element and the second side edge of a second contact shoe element which is adjacently neighboring to the first contact shoe element, wherein the sealing arrangement comprises
a refractory fabric which is folded to a substantially U-form shape having a first branch portion attached with refractory glue to the first side edge of the first contact shoe element and a second branch portion attached with refractory glue to the second side edge of the second contact shoe element,
at least one refractory felt strip which is arranged between the first and second branch portions to fill the space therebetween, and
a cover strip made of refractory fabric attached with refractory glue to the side faces of the first and second contact shoe element.

5. The sealing arrangement according to claim 4, wherein the sealing arrangement comprises a refractory bottom closure connected at the lower ends of first and second branch portions to form a bottom support for the refractory felt strip.

6. The sealing arrangement according to claim 4, wherein the refractory fabric comprises
a first edge portion folded from the first branch portion and attached with refractory glue to the side face of the first contact shoe element, and
a second edge portion folded from the second branch portion to an opposite direction in relation to the first edge portion and attached with refractory glue to the side face of the second contact shoe element.

7. The sealing arrangement according to claim 4, wherein the refractory fabric and/or the cover strip and/or the bottom closure is ceramic fabric or quartz fiber fabric.

8. The sealing arrangement according to claim 4, wherein the refractory felt strip is ceramic felt.
